(19) United States
(12) Patent Application Publication
(10) Pub. No.: US 2012/0226985 A1
(43) Pub. Date: Sep. 6, 2012

(54) HOSTED VIRTUAL DESKTOP DYNAMIC CONFIGURATION BASED ON END POINT CHARACTERISTICS

(76) Inventors: Steven CHERVETS, Longmont, CO (US); Stephan Edward Friedl, Frederick, CO (US); Thomas Martin Wesselman, Issaquah, WA (US)

(21) Appl. No.: 13/038,770

(22) Filed: Mar. 2, 2011

(51) Int. Cl. G06F 3/048; G06F 15/177

(52) U.S. Cl. 715/735; 715/733

(57) ABSTRACT

In accordance with an example embodiment, there is disclosed herein an apparatus comprising a communication interface configured to receive data representative of a virtual desktop, a user interface, and virtual desktop logic coupled with the communication interface and the user interface. The virtual desktop logic determines capabilities of the user interface and provides a virtual desktop on at least one component of the user interface based on the determined capabilities of the user interface.

### TECHNICAL FIELD

The present disclosure relates generally to Hosted Virtual Desktops (HVD).

### BACKGROUND

“Virtual desktop” is a term used within the WIMP (window, icon, menu, and pointing) paradigm for providing a user with an interface that mimics the interface of another device such as the user's desktop computer. Typically, the same interface is always provided. Some devices, such as mobile devices, however, have limited capabilities.

### BRIEF DESCRIPTION OF THE DRAWINGS

The accompanying drawings incorporated herein and forming a part of the specification illustrate the example embodiments.

FIG. 1 is a block diagram illustrating an example of an endpoint that configures a virtual desktop based on the endpoint's capabilities.

FIG. 2 is a block diagram where a network element determines the capabilities of an endpoint and provides a virtual desktop to the endpoint that comports with the capabilities of the endpoint.

FIG. 3 is a block diagram of a computer system upon which an example embodiment can be implemented.

FIG. 4 is a block diagram illustrating an example methodology for configuring a hosted virtual desktop to comport with the capabilities of the endpoint.

### OVERVIEW OF EXAMPLE EMBODIMENTS

The following presents a simplified overview of the example embodiments in order to provide a basic understanding of some aspects of the example embodiments. This overview is not an extensive overview of the example embodiments. It is intended to neither identify key or critical elements of the example embodiments nor delineate the scope of the appended claims. Its sole purpose is to present some concepts of the example embodiments in a simplified form as a prelude to the more detailed description that is presented later.

In accordance with an example embodiment, there is disclosed herein an apparatus comprising a communication interface configured to receive data representative of a virtual desktop, a user interface, and virtual desktop logic coupled with the communication interface and the user interface. The virtual desktop logic determines capabilities of the user interface and provides a virtual desktop on at least one component of the user interface based on the determined capabilities of the user interface.

In accordance with an example embodiment, there is disclosed herein an apparatus comprising a first communication interface configured to receive data representative of a virtual desktop, a second communication interface for communicating virtual desktop data to an endpoint, and virtual desktop logic coupled with the first communication interface and the second communication interface. The virtual desktop logic obtains data representative of capabilities of the endpoint via the second communication interface. The virtual desktop logic provides data representative of an endpoint virtual desktop to the endpoint via the second interface based on the capabilities of the endpoint.

In accordance with an example embodiment, there is disclosed herein a method comprising determining capabilities of a device with a user interface receiving a virtual desktop. The capabilities of the device are determined to ascertain whether the device will support a predefined application available from the virtual desktop. The user interface of the device is configured, so that the user interface provides a link to the predefined application responsive to determining the capabilities of the device support the predefined application.

In accordance with an example embodiment, there is disclosed herein logic encoded in at least one non-transitory computer readable media for execution by a processor, and when executed by the processor is operable to determine capabilities of a device with a user interface that is receiving a virtual desktop. The logic is further operable to configure the user interface of the device. The user interface provides a first set of links to a first set of predefined applications available via the virtual desktop responsive to determining the capabilities of the device support the first set of predefined applications.

### DESCRIPTION OF EXAMPLE EMBODIMENTS

This description provides examples not intended to limit the scope of the appended claims. The figures generally indicate the features of the examples, where it is understood and appreciated that like reference numerals are used to refer to like elements. Reference in the specification to “one embodiment” or “an embodiment” or “an example embodiment” means that a particular feature, structure, or characteristic described is included in at least one embodiment described herein and does not imply that the feature, structure, or characteristic is present in all embodiments described herein.

Disclosed in an example embodiment herein is a technique for providing a Hosted Virtual Desktop (HVD). An agent installed in an endpoint, the HVD or a network element can sense a client associated with an endpoint connecting to the HVD. The agent optimizes the desktop configuration so that it is specifically geared towards the capabilities of the endpoint. This permits a user to have a single global desktop which is accessible and usable from a wide variety of endpoint devices such as personal computers (PCs), thin client devices, and/or handheld devices such as smartphones.

In particular embodiments, the agent will dynamically change the virtual desktop composition and configuration based on changes to the configuration of an endpoint device. For example, while accessing a HVD from a smartphone, the smartphone may display a specific application that would ask the user if they want to view a document or make a VOIP call, or perhaps control their TV (which is also connected to the HVD) and would suppress the availability of standard PC productivity applications which are not usable from handheld devices. However, as soon as the user connects an external device such as a monitor, keyboard and/or mouse to the smartphone, then a regular Windows Desktop with a full suite of productivity applications could be displayed. As another example, if a handheld device is coupled with an HD (high definition) monitor but no keyboard or mouse is attached to the handheld device, the agent would enable HD video playback applications. As another example, if the endpoint is a thin client that lacks the local media processing capabilities to support video or audio conferencing from the endpoint, the agent would exclude those applications from the desktop when viewed through the thin client. However, if the endpoint is a PC with appropriate input devices (e.g., keyboard and/or mouse) and output devices (such as a monitor and speaker), a fully configured desktop is delivered to the endpoint. In an alternate embodiment, an agent resident on a network element modifies the desktop instead of using an agent resident in the desktop.

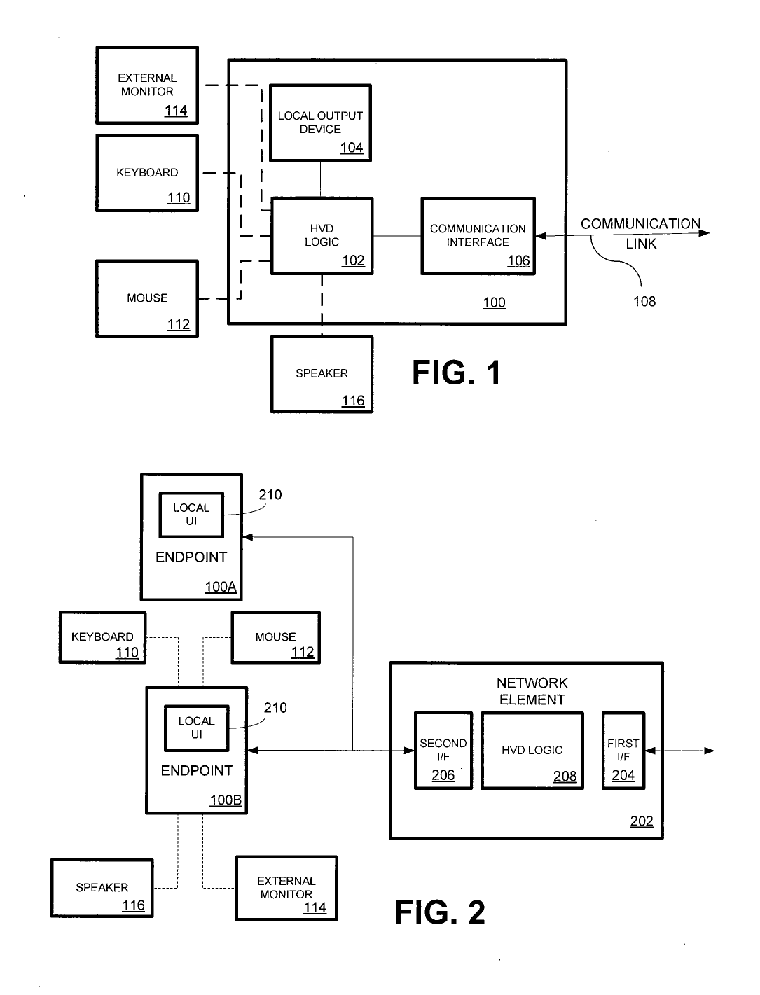

FIG. 1 is a block diagram illustrating an example of an endpoint device 100 that configures a virtual desktop based on the endpoint's capabilities. Endpoint device 100 comprises Hosted Virtual Desktop (HVD) logic 102, a local output device 104, and a communication interface 106.

In an example embodiment, HVD logic 102 receives data representative of a virtual desktop via communication interface 106. HVD logic 102 determines the capabilities of the user interface, local output device 104 in this example, and provides a virtual desktop on at least one component of the user interface based on the determined capabilities of the user interface. “Logic”, as used herein, includes but is not limited to hardware, firmware, software and/or combinations of each to perform a function(s) or an action(s), and/or to cause a function or action from another component. For example, based on a desired application or need, logic may include a software controlled microprocessor, discrete logic such as an application specific integrated circuit (ASIC), a programmable/programmed logic device, memory device containing instructions, or the like, or combinational logic embodied in hardware. Logic may also be fully embodied as software stored on a non-transitory, tangible medium which performs a described function when executed by a processor. Logic may suitably comprise one or more modules configured to perform one or more functions.

In an example embodiment, local output device 104 is a component, or a part of, a user interface. As used herein a “user interface” may suitably comprise an input device, such as a keyboard, an output device such as a monitor and/or audio output device, or a combination of an input device and an output device such as a touchscreen. In particular embodiments, the user interface may optionally include multiple input and/or output devices such as keyboard and mouse, high definition (HD) or external display, etc. Examples of other devices that may be a part of a user interface include but are not limited to keyboard 110, mouse, 112, external monitor 114, speaker 116, touch pad, touch screen, and/or game pad.

Communication 106 may be any suitable interface for receiving data representative of a virtual desktop from an external source (not shown), such as a user's home network. Communication interface 106 is coupled with the external source via communication link 108.

In an example embodiment, HVD logic 102 can detect a change in the user interface and changes the virtual desktop provided on the at least one component, e.g., local output device 104, responsive to the change in the user interface. For example, HVD logic 102 can detect whether an external keyboard (e.g., keyboard 110), external mouse (e.g., external mouse 112), external monitor (e.g. external monitor 114), and/or an audio output device (e.g. speakers 116) have been connected or disconnected. In an example embodiment, HVD desktop logic 102 determines whether to display, or not to display (suppress) an application on local output device 104 based on the detected user interface components. For example, if no external components are detected, HVD logic 102 can suppress the display of Word Processing, Spreadsheet, and other applications; however, upon detecting keyboard 110 and/or mouse 112 are connected to endpoint 110, HVD logic 102 may then change the virtual desktop and display icons or other provide other output (for example providing an audio signal on an audio output device such as speaker 116) indicating the availability of these applications. As another example, if the resolution of a video application is incompatible with local output device 104 the availability of the video application is suppressed; however, if an external monitor (e.g., monitor 114) is coupled with endpoint 100 that can process the video application, HVD logic 102 changes the desktop to indicate the video application is available.

In particular embodiments, the desktop may also be modified based on communication link 108. For example, if a wireless link is employed for communication link 108 and the wireless signal is too weak to provide a video stream, HVD logic 102 would suppress the availability of the video stream on local output device 104; however, if the signal becomes strong enough for the video stream, HVD logic 102 would change the virtual desktop to indicate the video stream is available.

In an example embodiment, HVD logic 102 may selectively output a virtual desktop on one or more devices. For example, if an external device, such as external monitor 114 is coupled with endpoint 100, HVD logic 102 may selectively display the virtual desktop on local output device 104, external monitor 114, or both. Another example could be where one of the end points is a thin client and another is a screen only which could display a media stream. With the idea being that one HVD could service server multiple end points. A mechanism that could be used to implement this type of sharing would be Terminal services, wherein each end point would get their own Terminal Services session with the same HVD. Each terminal services session will display a different application.

In an example embodiment, HVD logic 102 may render any number of virtual desktops based on the configuration of endpoint 100. For example, if no external devices, e.g., keyboard 110, mouse, 112, external monitor 114, and speaker 116 are detected, HVD logic 102 may provide a first set of applications on the virtual desktop based on the capabilities of the user interface, local output device 104 in this example. HVD logic 102 provides set of applications with the virtual desktop responsive to detecting a first change in the user interface. For example, if HVD logic 102 detects that one of the group consisting of keyboard 110 and mouse 112 is coupled with endpoint 100, HVD logic 102 provides a second set of applications with the virtual desktop. If HVD logic 102 detects a second change in the user interface, for example another device is connected such as external monitor 114 and/or speaker 116, or a device is disconnected from the user interface, HVD logic 102 may provide a third set of applications with the virtual desktop. From the foregoing, one skilled in the art can readily appreciate that applications available on endpoint 100 may be dynamically changed any time there is a change to the configuration of endpoint 100.

FIG. 2 is a block diagram where a network element 202 determines the capabilities of an endpoint 200 and provides endpoint 100A with a virtual desktop that comports with the capabilities of endpoint 100A. In the illustrated example, network element 202 comprises a first interface (I/F) 204 that receives data representative of a virtual desktop, and a second interface 206 coupled with endpoint 200, and HVD logic 208 coupled with first interface 204 and second interface 206.

HVD logic 208 obtains, via second interface 206, data representative of the capabilities of endpoint 100A. For example, endpoint 200 may provide the capabilities of local user interface (UI) 210 and whether keyboard 110, mouse 112, external monitor 114, and/or speaker 116, or any combination thereof, are coupled with endpoint 100A, in the illustrated example endpoint 100A is configured with UI 210, keyboard 110 and mouse 112. HVD logic 208 receives data representative of a virtual desktop for endpoint 100A via first interface 204. HVD logic 208 provides data representative of an endpoint virtual desktop to endpoint 100A via second communication interface 206 based on the capabilities of endpoint 100A.

In an example embodiment, network element may be coupled with a plurality of endpoints, 100A, 100B. Although the illustrated example shows two endpoints, those skilled in the art should readily appreciate that any physically realizable number of endpoints may be connected to network element 202. HVD logic 208 obtains data representative of capabilities of endpoint 100B via second communication interface 206. HVD logic 208 provides data representative of a second endpoint virtual desktop to endpoint 100B based on the capabilities of endpoint 100B via second communication interface 206. Thus, HVD logic 208 may provide different virtual desktops to different endpoints 100A, 100B based on their capabilities. For example, endpoint 100A may be provided with a first set of applications with its virtual desktop based on the capabilities of endpoint 100A and endpoint 100B may be provided with a second set of applications with its virtual desktop based on the capabilities of endpoint 100B.

In an example embodiment, HVD logic 208 may change the virtual desktop to an endpoint upon detecting a change in the configuration of the endpoint. For example, if no external devices, e.g., keyboard 110, mouse, 112, external monitor 114, and speaker 116 are detected coupled with endpoint 100A, HVD logic 208 may provide a first set of applications on the virtual desktop to endpoint 100A based on the capabilities of local user interface 210. If HVD logic determines that the configuration of endpoint 100A has changed, e.g., one or more of keyboard 110, mouse 112, external monitor 114, and speaker 116 are connected to, or disconnected from, endpoint 100A, HVD logic 208 changes the virtual desktop provided to endpoint 100A. For example, a first set of applications may be provided with the virtual desktop before a change is detected and a second set of applications may be provided with the virtual desktop after the change is detected.

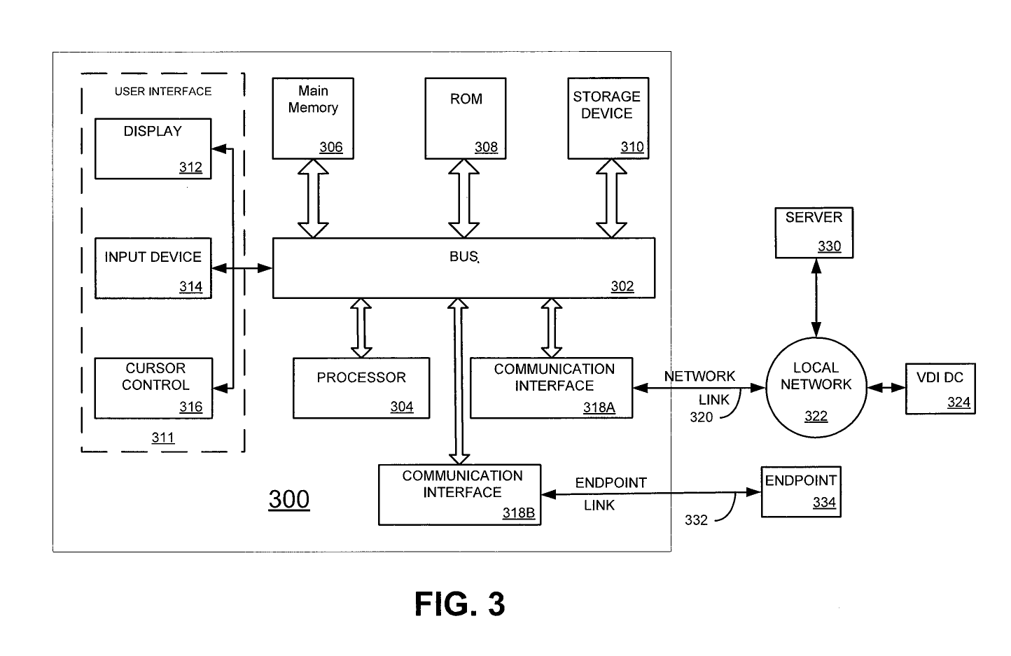

FIG. 3 is a block diagram of a computer system upon which an example embodiment can be implemented. Computer system 300 includes a bus 302 or other communication mechanism for communicating information and a processor 304 coupled with bus 302 for processing information. Computer system 300 also includes a main memory 306, such as random access memory (RAM) or other dynamic storage device coupled to bus 302 for storing information and instructions to be executed by processor 304. Main memory 306 also may be used for storing a temporary variable or other intermediate information during execution of instructions to be executed by processor 304. Computer system 300 further includes a read only memory (ROM) 308 or other static storage device coupled to bus 302 for storing static information and instructions for processor 304. A storage device 310, such as a magnetic disk or optical disk, is provided and coupled to bus 302 for storing information and instructions.

Computer system 300 may be coupled via bus 302 to a user interface 311 comprising a display 312, input device 314, and/or cursor control 316. Display 312 such as a liquid crystal display (LCD), for displaying information to a computer user. An input device 314, such as a keyboard including alphanumeric and other keys is coupled to bus 302 for communicating information and command selections to processor 304. Another type of user input device is cursor control 316, such as a mouse, a trackball, cursor direction keys, and/or a touchscreen for communicating direction information and command selections to processor 304 and for controlling cursor movement on display 312. This input device typically has two degrees of freedom in two axes, a first axis (e.g. x) and a second axis (e.g. y) that allows the device to specify positions in a plane.

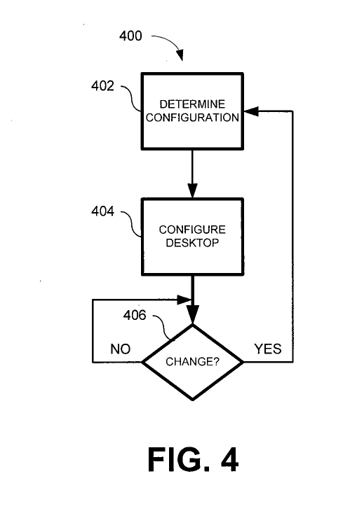

An aspect of the example embodiment is related to the use of computer system 300 for implementing a virtual desktop. According to an example embodiment, implementing a virtual desktop is provided by computer system 300 in response to processor 304 executing one or more sequences of one or more instructions contained in main memory 306. Such instructions may be read into main memory 306 from another computer-readable medium, such as storage device 310. Execution of the sequence of instructions contained in main memory 306 causes processor 304 to perform the process steps described herein. One or more processors in a multi-processing arrangement may also be employed to execute the sequences of instructions contained in main memory 306. In alternative embodiments, hard-wired circuitry may be used in place of or in combination with software instructions to implement an example embodiment. Thus, embodiments described herein are not limited to any specific combination of hardware circuitry and software. Computer system 300 may be employed for implementing endpoint 100 (FIG. 1), processor 304 executes instructions to perform the functionality of HVD logic 102 (FIG. 1); network elements 202 (FIG. 2), processor 304 executes instructions to perform the functionality of HVD logic 208 (FIG. 2); endpoint 304 (FIG. 3); enterprise component 304 (FIG. 3); switch router 402 (FIG. 4), processor 304 executes instructions to perform the functionality of proxy connection logic 506; gateway provider 602 (FIGS. 6 and 7); and/or service provider gateway 800 (FIG. 8), processor 304 executes instructions to perform the functionality of service provider gateway logic 806.

The term “computer-readable medium” as used herein refers to any medium that participates in providing instructions to processor 304 for execution. Such a medium may take many forms, including but not limited to non-volatile media, and volatile media. Non-volatile media include for example optical or magnetic disks, such as storage device 310. Volatile media include dynamic memory such as main memory 306. As used herein, tangible media may include volatile and non-volatile media. Common forms of computer-readable media include for example floppy disk, a flexible disk, hard disk, magnetic cards, paper tape, any other physical medium with patterns of holes, a RAM, a PROM, an EPROM, a FLASHPROM, CD, DVD or any other memory chip or cartridge, or any other medium from which a computer can read.

Computer system 300 also includes a communication interfaces 318A, 318B coupled to bus 302. Communication interface 318A provides a two-way data communication coupling computer system 300 to a network link 320 that is connected to a local network 322.

For example, communication interface 318 may be a local area network (LAN) card to provide a data communication connection to a compatible LAN. As another example, communication interface 318 may be an integrated services digital network (ISDN) card or a modem to provide a data communication connection to a corresponding type of telephone line. Wireless links may also be implemented. In any such implementation, communication interface 318 sends and receives electrical, electromagnetic, or optical signals that carry digital data streams representing various types of information.

Network link 320 typically provides data communication through one or more networks to other data devices. For example, network link 320 may provide a connection through local network 322 to a virtual desktop implementation desktop client (VDI DC) 324. In addition, local network 322 may be coupled with a server 330 that is sourcing image and/or media data, enabling media and/or image data to be obtained by computer system 300 while bypassing HVD virtual machine 324.

Communication interface 318B is coupled to endpoint link 332. Endpoint link 332 provides data communication with an endpoint device 334. This allows computer system to receive virtual desktop endpoint requests and to provide virtual desktop data from HVD virtual machine 324 and server 330 to endpoint 334. Although the illustrated example shows two communication interface 318A, 318B those skilled in the art should readily appreciate that this is for ease of illustration and that any physically realizable number of interfaces may be coupled to bus 302.

In view of the foregoing structural and functional features described above, a methodology in accordance with an example embodiment will be better appreciated with reference to FIG. 4. While, for purposes of simplicity of explanation, the methodology of FIG. 4 is shown and described as executing serially, it is to be understood and appreciated that the example embodiment is not limited by the illustrated orders, as some aspects could occur in different orders and/or concurrently with other aspects from that shown and described herein. Moreover, not all of the illustrated features may be required. The methodology described herein is suitably adapted to be implemented in hardware, software, or a combination thereof.

FIG. 4 is a block diagram illustrating an example methodology 400 for configuring a hosted virtual desktop to comport with the capabilities of an endpoint. Methodology 1000 may be implemented by HVD logic 102 (FIG. 1), HVD logic 208 (FIG. 2) and/or processor 304 (FIG. 4).

At 402, the configuration of the endpoint device is determined. The determination may include, but is not limited to, the type of video display available, type of audio device available, type of input device, type and characteristics (such as available bandwidth) of network connection, and/or processing capabilities available at the endpoint.

At 404, the desktop is configured based on the endpoint's capabilities. For example, applications the endpoint supports are available on the desktop (e.g., displayed) while applications which the endpoint are unable to run are suppressed.

At 406, a determination is made whether the endpoint configuration changed. This allows the method to dynamically adjust the virtual desktop in response to changes in the endpoint configuration. For example, if a keyboard or external monitor are connected to endpoint, or a change in the endpoint's network connectivity. If the configuration has changed (YES), then 402 and 404 are repeated. If the configuration has not changed (NO), then no changes are made to the desktop.

Described above are example embodiments. It is, of course, not possible to describe every conceivable combination of components or methodologies, but one of ordinary skill in the art will recognize that many further combinations and permutations of the example embodiments are possible. Accordingly, this application is intended to embrace all such alterations, modifications and variations that fall within the spirit and scope of the appended claims interpreted in accordance with the breadth to which they are fairly, legally and equitably entitled.

1. An apparatus, comprising:
a communication interface configured to receive data representative of a virtual desktop;
a user interface; and
virtual desktop logic coupled with the communication interface and the user interface;
wherein the virtual desktop logic determines capabilities of the user interface; and
wherein the virtual desktop logic provides a virtual desktop on at least one component of the user interface based on the determined capabilities of the user interface.

2. The apparatus set forth in claim 1, wherein the virtual desktop logic detects a change in the user interface; and
wherein the virtual desktop logic changes the virtual desktop provided on the at least one component responsive to the change in the user interface.

3. The apparatus set forth in claim 2, wherein the change in the user interface is a detected addition of one of a group consisting an external keyboard, an external mouse, an external monitor, a headset, and a speaker.

4. The apparatus set forth in claim 2, wherein the virtual desktop logic suppresses availability of an application before the change in the user interface based on determining the application is not compatible with the user interface;
wherein the virtual desktop logic is responsive to detecting the change in the user interface to determine whether the application is compatible with the changed user interface; and
wherein the virtual desktop logic provides data indicating the availability of the application responsive to determining the application is compatible with the changed user interface.

5. The apparatus set forth in claim 4, wherein the virtual desktop logic determines whether to automatically launch an application based on current capabilities of the changed user interface.

6. The apparatus set forth in claim 1, wherein the virtual desktop logic detects a first change in the user interface;
wherein the virtual desktop logic outputs a first set of applications on the user interface based on the capabilities of the user interface prior to detecting the change;
wherein the virtual desktop logic outputs a second set of applications on the user interface based on the capabilities of the user interface upon detecting the first change;
wherein the virtual desktop logic detects a second change in the user interface; and
wherein the virtual desktop logic outputs a third set of applications on the user interface based on the capabilities of the user interface upon detecting the second change.

7. An apparatus, comprising:
a first communication interface configured to receive data representative of a virtual desktop;
a second communication interface for communicating virtual desktop data to an endpoint; and
virtual desktop logic coupled with the first communication interface and the second communication interface;
wherein the virtual desktop logic obtains data representative of capabilities of the endpoint via the second communication interface; and
wherein the virtual desktop logic provides data representative of an endpoint virtual desktop to the endpoint via the second interface based on the capabilities of the endpoint.

8. The apparatus of claim 7, wherein the data representative of an endpoint virtual desktop comprises a first set of applications compatible with the capabilities of the endpoint;
wherein the virtual desktop logic is coupled with a second a second endpoint;
wherein the virtual desktop logic obtains data representative of capabilities of the second endpoint via the second communication interface;
wherein the virtual desktop logic provides data representative of a second endpoint virtual desktop to the endpoint based on the capabilities of the second endpoint via the second communication interface; and
wherein the data representative of a second endpoint comprises a second set of applications compatible with the capabilities of the second endpoint.

9. The apparatus set forth in claim 7, wherein the virtual desktop logic detects a change in the capabilities of the endpoint; and
wherein the virtual desktop logic changes the data representative of an endpoint virtual desktop provided to the endpoint responsive to the change in the user interface.

10. A method, comprising:
determining capabilities of a device with a user interface receiving a virtual desktop;
determining whether the capabilities of the device will support a predefined application available from the desktop; and
configuring the user interface of the device;
wherein the user interface provides a link to the predefined application responsive to determining the capabilities of the device supports the predefined application.

11. The method set forth in claim 10, further comprising:
detecting a change of the capabilities of the device; and
re-configuring the user interface of the device responsive to detecting the change of the capabilities of the device.

12. The method set forth in claim 11, wherein re-configuring the user interface comprises suppressing access to the link to the predefined application responsive to determining the device no longer supports the predefined application after detecting the change in capabilities.

13. The method set forth in claim 11, wherein the change in the user interface is a detected addition of one of a group consisting of an external input device, a video device, and an audio device to the device.

14. The method set forth in claim 11, wherein the change in the user interface is a detected addition of one of a group consisting of an external keyboard, an external mouse, an external display device, an external speaker, and an external printer.

15. The method set forth in claim 10, further comprising determining whether to launch the predefined application based on the capabilities of the device.

16. Logic encoded in at least one non-transitory computer readable media for execution by a processor, and when executed by the processor operable to:
determine capabilities of a device with a user interface that is receiving a virtual desktop; and
configuring the user interface of the device;
wherein the user interface provides a first set of links to a first set of predefined applications available via the virtual desktop responsive to determining the capabilities of the device support the first set of predefined applications.

17. The logic of claim 16, further operable to:
detect a change of the capabilities of the device; and
re-configure the user interface of the device responsive to detecting the change of the capabilities of the device;
wherein the re-configured user interface provides a second set of links to a second set of predefined applications available via the virtual desktop responsive to determining the capabilities of the device support the second set of predefined applications.

18. The logic of claim 17, further operable to:
determine whether a predefined application selected from the second set of applications should be automatically launched based on the change of the capabilities of the device; and
launch the predefined application responsive to determining that the predefined application should be automatically launched based on the change of the capabilities of the device.

19. The logic of claim 17, wherein the detected change in the user interface is an addition of one of a group consisting of external input device, a video device, and an audio device to the device.

20. The logic of claim 17, wherein the detected change in the user interface is a removal of one of a group consisting of external input device, a video device, and an audio device to the device.
